(19) United States
(12) Patent Application Publication
(10) Pub. No.: US 2006/0274662 A1
(43) Pub. Date: Dec. 7, 2006

(54) MEANS AND METHOD OF INTEGRATED INFORMATION TECHNOLOGY MAINTENANCE SYSTEM

(75) Inventor: Adam Tannenbaum, Givat Ze'ev (IL)

Correspondence Address: GOTTLIEB RACKMAN & REISMAN PC, 270 MADISON AVENUE, 8TH FLOOR, NEW YORK, NY, 100160601, US

(73) Assignee: Fail Safe Solutions, LLC, Hillside, NJ (US)

(21) Appl. No.: 11/422,385

(22) Filed: Jun. 6, 2006

(30) Foreign Application Priority Data
Jun. 7, 2005 (IL) 169064

(51) Int. Cl. H04J 3/14

(52) U.S. Cl. 370/242; 370/401

(57) ABSTRACT

The present invention relates to the field of information technology system maintenance and particularly to integrated, full solution, computer maintenance architecture and a device that is independent from the computers being monitored and maintained. A computer supervising device that comprises a processor; internal memory in communication with the processor; a storage device in communication with the processor; an internal bus that provides a communication path between the processor, memory and storage device; an operating system in communication with the processor; a data maintenance management module; an operating system management module; a communications device for communicating with computers to be supervised; and an interface that integrates all supervising functions in a single interface.

This invention claims priority to Israel Application No. 169064 filed Jun. 07, 2005.

### FIELD OF THE INVENTION

The present invention relates to the field of information technology system maintenance and more particularly to an integrated, full solution, computer maintenance architecture and device that is independent from the computers to be monitored and maintained.

### BACKGROUND OF THE INVENTION

Information systems management, including computer system maintenance and troubleshooting, is a massive worldwide market. U.S. companies alone outlay billions of dollars a year on hardware and software solutions and information technology (“IT”) experts and technicians to keep their network servers and PC's and workstations on their network running properly. Moreover, many companies spend millions of dollars each year on mission-critical IT support. It is not unusual for even small businesses having less than 50 employees to spend tens, and even hundreds, of thousands of dollars a year on their IT needs. The vast resources poured into the IT industry is understandable in view of the revolutionary shift of world markets from industry/product-based economies to services and information-based ones and the dependence of old economy businesses on computers. In this environment, the need for most companies to maintain their information systems at peak functioning conditions is indeed critical.

Many companies produce a variety of types of IT solutions to support this market. Some provide hardware management programs such as IBM Tivoli or BMC Patrol, operating system (OS) utilities that either are bundled with the OS or are standalone products, and application utilities. Others are service organizations that provide on-site IT staff, or “agents,” on an as-needed basis. These agents respond, for example, to a network or critical computer failure or for scheduled computer system maintenance. Moreover, many companies maintain an in-house IT staff comprising one or even teams of IT agents that monitor, update and repair company networks, hardware (the computers themselves) and software and to serve as help desk personnel. More recently, the Internet has been playing an increasingly important role in IT management, making possible both (1) efficient access to target systems (servers, workstations and PC's) from a remote location, and (2) access from the target systems to remote locations. The Internet, however, has had the unwanted effect of increasing the need to protect the company networks and data from the outside (i.e. unauthorized users, hackers, viruses). This has spawned a large sub-market in the computer maintenance field, broadly called computer security industry, and includes product categories such as firewalls, encryption, misuse detection, and virus protection, to name a few.

The tasks of computer system management can be broadly broken down into the following categories: (a) operating systems management; (c) data management; (c) hardware management; and (d) application programs management. Within a network environment, the task is complicated by the need for (d) network administration or management. Each of these management categories entails gathering requirements, purchasing hardware equipment and/or software, distributing the hardware and software to where it is to be used, configuring them, maintaining them with enhancement and service updates, setting up problem-handling processes, solving problems that occur, assisting users of the systems and determining whether the management objectives are being met.

Unfortunately, conventional solutions tend to focus only on one or another aspect of the entire IT needs of the system, and to institute all individual solutions, still results in an unwieldy collection of devices that have separate needs for purchasing, installation, upgrading, management, maintenance and support. None provide a comprehensive solution for the systems administrator. Consequently, the systems management function entails the often complicated and always costly tasks of purchasing and integrating numerous discrete software and hardware solutions from different IT vendors. These components add integration and labor costs and pose significant burdens on any sized enterprise as the costs rise relative to the size of the operation.

Further, current software and hardware solutions decrease companies' reliance on IT agents only to limited degree. For example, Symantec™ Corp. offers several suites of security and maintenance utilities that can be loaded onto a PC and run when desired. Microsoft™ also offers with its operating systems general operating system utilities and some crude install/uninstall utilities and system clean-up utilities such as defragmentors. Some companies have attempted to automate IT maintenance.

Unfortunately, software utilities often do not operate as well as intended. Further, these so-called “automated” software maintenance and repair utilities are often only as good as the support personnel using them.

Accordingly, there is a need for a robust, full-featured, integrated PC monitoring and maintenance solution that is both reliable, affordable, and independent from the computers to be maintained. It must be an automated solution that resides on the system (server, network) being monitored. The IT manager should be able to manage this system with remote control software.

### BRIEF DESCRIPTION OF THE DRAWINGS

In order to understand the invention and to see how it may be implemented in practice, a preferred embodiment will now be described, by way of non-limiting example only, with reference to the accompanying drawing, in which

FIG. 1 is a simplified diagram of the maintenance device of the present invention in communication with a computer;

FIG. 2 is a diagram of the device of the present invention connected to a network of computers and to external communications devices;

FIG. 3 is a simplified diagram showing the hardware components of the device of the present invention;

FIG. 4 is a high level schematic showing the maintenance modules and internal communications architecture of the server of the present invention in communication with a client computer to be maintained;

FIG. 5 is a flow diagram that describes the remote boot options of the present invention that are available to a client at start-up

FIG. 6 is a flow diagram that describes the “remote reset-off” feature of the server of the present invention;

FIG. 7 is a flow diagram that describes the “remote reset-on” feature of the server of the present invention; and

FIG. 8 is a flow diagram that depicts the remote voice alert notification feature of the server of the present invention.

### SUMMARY OF THE INVENTION

It is thus one object of the present invention to provide a computer maintenance device. This computer supervising device is inter alia comprised of a processor; internal memory in communication with the processor; a storage device in communication with the processor; an internal bus that provides a communication path between the processor, memory and storage device; an operating system in communication with the processor; a data maintenance management module that operates from the memory; an operating system management module that that operates from the memory; communications means for communicating with computers to be supervised; and an interface that integrates all supervising functions in a single interface.

According to yet another embodiment of the present invention, the device additionally comprising remote communications means for enabling communication with remote control devices including a bi-directional phone access control (PAC) component and the TCP/IP protocol.

The device comprising a processor; internal memory in communication with the device's processor; a storage device in communication with the device's processor; an internal bus that provides a communication path between the device's processor, memory and storage device; an operating system in communication with the device's processor; a data maintenance management module that operates from the internal memory that is adapted to dynamically back up data stored on the storage device of each of the selected computers to a backup storage device associated with the independent device, maintain temporary files stored on the storage device, scan the storage device for viruses, scan the storage device to maintain file system integrity and storage optimization, and manage storage device usage; an operating system management module that that operates from the memory and that is adapted to selectively boot and reboot a selected operating system onto a selected computer; detect operating system failures in the selected computers and in the event of a failure of an operating system of one or more of the selected computers, restoring the operating system to a prior stable operating state; network communications means for communicating with the selected computers to be supervised; and remote communications means for enabling remote control of the device, wherein the device is independent from the computers on the network. A self-monitoring computer maintenance system for maintaining a network of computers, includes the device and a computer maintenance administration module connectable to the device and adapted to control the device.

It is therefore one object of the present invention to present a cost effective method of maintaining a computer system having a processor, an operating system, main memory and a storage device. Said method comprising inter alia the steps of in an independent, processor-based device in communication with the computer system, selecting one or more predefined maintenance tasks to be performed; and executing from the device the one or more tasks on the computer system.

The method additionally comprising prior to executing, scheduling the one or more predefined maintenance tasks for execution wherein the predefined maintenance tasks comprising managing the operating system of the computer system; and managing data stored on the storage device of the computer system.

It is another object of the present invention to present a cost effective method wherein the managing of the data stored on the storage device includes dynamically backing up the data to a backup storage device associated with the independent device including a real-time operating system.

The one or more predefined maintenance tasks to be executed are scheduled remotely from the device; the maintenance tasks to be performed are selected remotely from the device.

It is another object of the present invention to present a cost effective method of maintaining a network of computers, comprising selecting, in an independent, processor-based device in communication with the network of computers, one or more computers on the network to be maintained; selecting, from the independent device, one or more predefined maintenance tasks to be performed on each of the selected computers; and executing the one or more selected predefined maintenance tasks on each of the selected computers.

The method additionally comprising prior to executing, scheduling the one or more selected maintenance tasks for execution wherein the executing of the one or more selected maintenance tasks recurs on each of the selected computers according to the scheduling.

The method wherein each of the selected one or more computers on the network includes a processor, an operating system, main memory and is associated with a storage device, and wherein the one or more predefined maintenance tasks to be performed comprises managing the operating system of each of the one or more selected computers on the network; and managing data stored on the storage device associated with each of the one or more selected computers on the network.

The method wherein the managing of the operating systems of the selected computers includes at least one of booting and rebooting an operating system onto a selected computer; detecting failures in the operating systems of the selected computers; and in the event of a failure of an operating system of one or more of the selected computers, restoring the operating system to a prior stable operating state.

The method, wherein the managing of the data stored on the storage device associated with each of the selected computers includes at least one of maintaining temporary files stored on the storage device; scanning the storage device for viruses; scanning the storage device to maintain file system integrity and storage optimization; and managing disk usage.

The method, further including managing the main memory of each of the selected computers.

The method, wherein the managing of the main memory includes monitoring each of the selected computer's main memory usage; and optimizing each of the selected computer's main memory usage.

The method, wherein the network of computers comprises a heterogeneous operating system environment, further includes automatically detecting the operating system platform of each of the selected computers to be managed.

### DETAILED DESCRIPTION OF THE DRAWINGS

The following description is provided, alongside all chapters of the present invention, so as to enable any person skilled in the art to make use of said invention and sets forth the best modes contemplated by the inventor of carrying out this invention. Various modifications, however, will remain apparent to those skilled in the art, since the generic principles of the present invention have been defined specifically to provide an integrated, full solution, computer maintenance architecture and device that is independent from the computers to be monitored and maintained.

The present invention discloses a new platform, device, method and related features for monitoring and maintaining one or more computer systems. The present invention is implemented as a powerful platform for maintaining both computers (PC's and other servers) in a network, and as a supervisor for a single standalone computer. Accordingly, the following sections describe alternative embodiments of the VITA device.

First, a simplified version of the inventive maintenance device, or server, that monitors and supports a single computer, is described. Next, a network version of the inventive server operating in the network environment is shown. The hardware components of the network version are then described in detail. It will be understood that much of the functionality of the first description will apply to a VITA on a network configuration, by merely applying the functionality of the VITA to many clients and servers. Next, the maintenance software modules that are stored on and operate from the device are detailed. These modules are included in both the single computer and network configurations. Finally, the communications architectures, both internal to the network to which the server is connected and external to the network (remote administration) are described.

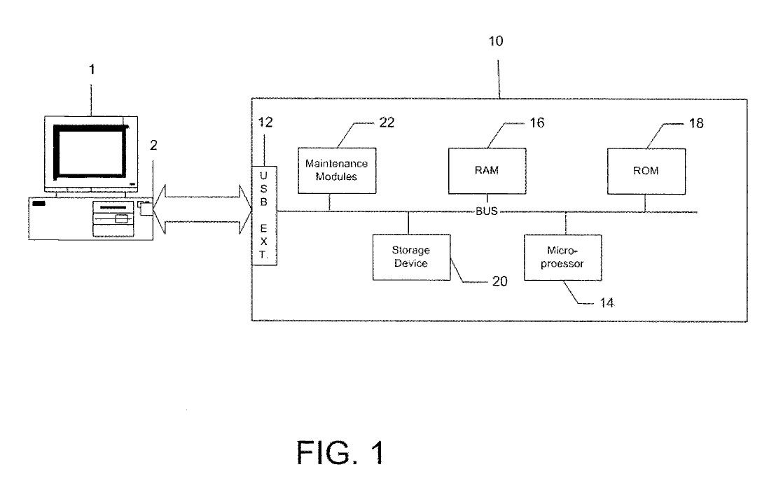

Reference is made now to FIG. 1, presenting the preferred configuration for the version of the inventive device that monitors and maintains a single, mission critical computer as shown in the simplified block diagram. The maintenance device 10 is a box (not drawn to scale) having a Universal Serial Bus (USB) extension 12 for connecting to the USB port 2 of a standalone computer, such as a PC, 1 to be maintained. The device includes numerous components typically found in a computer, including a processor, or more particularly a microprocessor 14, random access memory (RAM) 16, read only memory (ROM) 18, a storage block 22 for storing the maintenance software modules of the present invention (not shown here), and at least one storage device 22, such as a hard drive, for storing the various databases created by operation of the maintenance modules. The hardware components in the box 10 communicate with each other via a local bus 24. As discussed in detail below, the maintenance modules (programs) stored in the storage block 22 comprise the various programs and utilities that provide the device's functionality. It should be understood that while FIG. 1 depicts these software modules in a storage block that is separate from the storage device 20, they may actually reside on the storage device. Moreover, the storage device 20 may alternatively be located external to the box 10 or may have complementary drives external to the box.

As explained in greater detail below with respect to the network architecture embodiment, the device 10 of the present invention, first shifts all, or as much as is desired, computer maintenance functionality that is conventionally executed by software that resides on the computer 1 itself (as application programs and utilities) to a piece of hardware 10 that operates independently of the computer; and adds other maintenance functionality that is not conventionally found on or offered for computers. This shift provides important benefits, especially for the mission critical computer. First, it tends to improve system reliability and robustness. The reason is that, conventionally, a PC fault or failure is addressed (attempted resolution) by the PC itself, whose failure may be severe enough to disable, freeze, or corrupt its critical components, such as the operating system or memory or storage, thereby making problem resolution difficult or even impossible. The device of the present invention, however, eliminates this problem. Second, this configuration frees the processor in the computer from executing intensive support and maintenance tasks. Reducing the demands on the processor (such as receiving competing simultaneous processing requests) tends to reduce processor and system conflicts and faults. Moreover, reducing the demands on the processor tends to improve the overall operating speed of the computer.

The applications for the standalone computer version of the device are numerous. As processing power and storage capacity continue to increase (e.g. Moore's law) and costs decrease, many small businesses and professional practices have found that all or most of their business computing needs (i.e., accounting, client and sales data) can be met with a single computer. Thus, even if cost is not a primary issue, such a single “mission critical” computer may be sufficient for such an environment. The device of the present invention can fulfill the important needs of improved reliability, decreased downtimes and a reduction in the need for outside IT professionals to solve computer problems.

The following discussion of the networked version of the present invention relates to a device and method that operates in a client-server LAN environment using the bus topology. However, it should be understood that the device and method can be designed for a broad range of network architectures, topologies, data link layers and sizes.

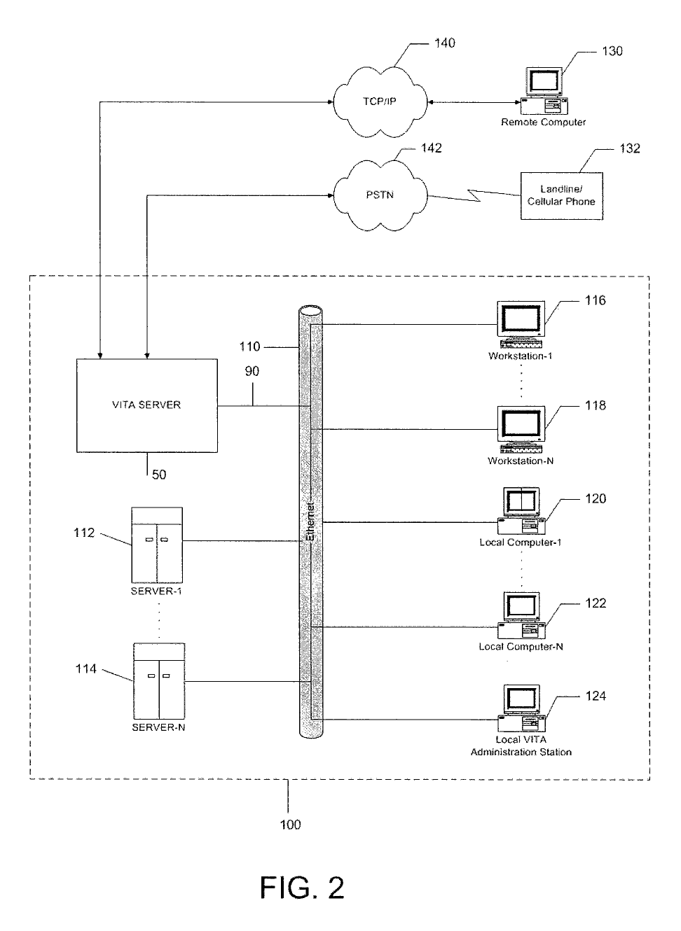

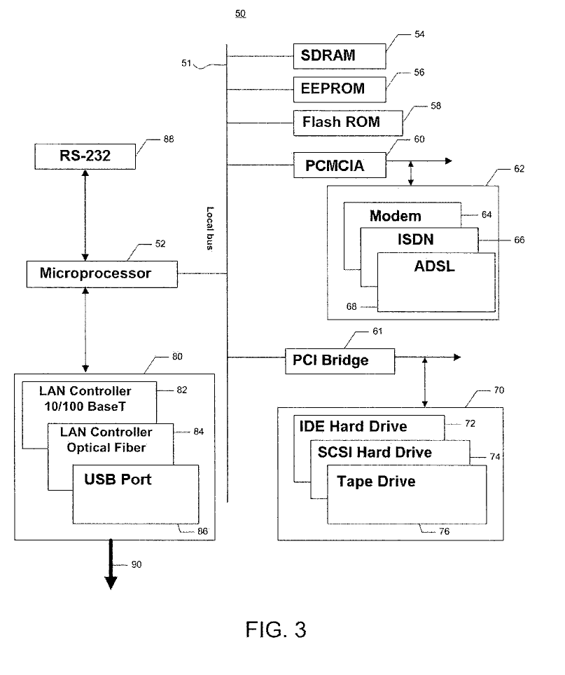

Reference is made now to FIG. 2, schematically presenting a high-level of one network environment in which the device of the present invention may preferably operate. In particular, FIG. 2 depicts an exemplary Ethernet Local Area Network (LAN) 100, as found in many typical office environments. The device, referred to herein as the virtual information technology, or VITA, server 50, includes a LAN controller 80, which may be, for example, a 10/100 BaseT controller 82, an optical fiber controller 84 (shown in FIG. 3), or other appropriate controller that connects to the Ethernet bus 110 via communications path 90. Similarly, one or more servers, denoted as SERVER-1 112 through SERVER-N 114 are connected to the LAN to serve a plurality of client computers on the network, namely, Workstation-1 116 through Workstation-N 118 and Local Computer-1 120 through Local Computer-N 122. Further, the VITA server 50 preferably communicates with and can be controlled by devices that are remote from the network 100, such as a remote computer 130 via a TCP/IP connection, or a telephone 132 via a telephone network 142. These options are used for remote administration of the network computers via the VITA server 50.

Reference is made now to FIG. 3, schematically presenting the preferred hardware architecture of the VITA server 50 shown in FIG. 2. As seen, the device 50 includes many of the hardware components typically found in a conventional server. In particular, a processor 52, memory 54, and ROM 56, 58, all communicate with each other via a local bus 51. Mass storage general denoted by box 70 is also provided and is connected to the bus 51 via a peripheral component interface, or PCI, bridge 61. External communications means 62 is also provided and communicates with the processor 52 via a PCMIA bus 60 connected to the local bus 51. Each of these components is now discussed in greater detail.

The processor 52 preferably has a-32 bit architecture to support the PCI protocol. It is preferable to use a communications-oriented processor to take advantage of its comprehensive built-in protocol support such RS-232, network, and others protocols. In view of this, the preferred processor implemented by the present invention is the PowerPC™ MPC860 microprocessor from Motorola™. In addition, this processor is based on RISC technology, which significantly increases its performance. However, it will be appreciated that other appropriate processors may be used.

The ROM comprises flash memory 58 within which is stored the operating system and the various software modules of the VITA device. The flash ROM 58 is accessed only by the microprocessor 52 in read/write mode. Also included is EEPROM 56, which is used to store a minimal configuration of the VITA device. The EEPROM is accessed only by the processor in read/write mode.

The preferred operating system is a real time operating system (RTOS) that is reliable and robust, and capable of managing the many possible concurrent requests from VITA agents with a minimum of delay. One such preferred system is VxWorks by WindRiver Corp. However, it should be understood that other operating systems may be used.

At run time, the RAM, and preferably synchronous DRAM, 54 contains the operating system and the different modules of VITA. In addition, there must be sufficient additional working space for both the OS and the programs. All active devices access the RAM in read or write mode.

As seen, a PCI bus 61 is shared between one or more PCI based devices. This gives the VITA server an access to the vast number of open technology-based cards on the market. In practice, as seen in FIG. 3, the PCI bus forms a bridge between the microprocessor 52 and one or more mass storage devices 70 such as an IDE hard drive 72, a SCSI hard drive 74 or a tape drive 76. In one embodiment, the bus is clocked at 33 MHz.

The PCMCIA bus 60 is shared between one or more PCMCIA-based devices. As shown, in the preferred embodiment, it is used to form a bridge between the microprocessor 52 and an external communication device 62, such as a modem 64, an ISDN controller 66 or ADSL devices 68.

A USB bus 86 may also be included for configurations that supervise a single computer, in which case, the USB port is used instead of the network card to connect to the computer.

The mass storage device 70 contains the database for each module of the server. In one embodiment, the specific storage device used (type and capacity) is left to the user. Alternatively, the device may be pre-installed in the server. In either case, the preferred device 50 supports IDE drives with an IDE controller 72 and SCSI drives with a SCSI controller 74. The IDE controller supports up to four hard disks, while the SCSI controller supports up to seven.

Because the VITA server is targeted at large enterprises as well as mid-sized organizations, the preferred device also accommodates faster and more secure storage technologies such as RAID or Mirror. Accordingly for the enterprise version, the device may be equipped with an IDE RAID or SCSI RAID controller.

As VITA is a fully integrated solution, a tape drive will be supported as well with a tape drive controller 76. This efficiently enables the creation of a backup history and frees space on mass storage when a certain threshold is reached.

The communications functions of the device of the present invention can be separated into two groups. The first is the external communications subsystem, and the second is the internal communications subsystem.

The external communications capability is a recommended extension, which will allow an access to VITA from any point on the globe. The device used for this can be an analog, ISDN or ADSL modem and can be driven by either the PCI or the PCMCIA buses, depending on the hardware interface. The appropriate device will be determined by the desired bandwidth. Another possibility is to give access to VITA via the target site's network server, if the network configuration allows this. Nevertheless, this is not recommended because VITA must remain entirely independent of the rest of the system.

As stated above, the VITA server must be linked to the monitored computers either by a LAN connection (in a network environment) or a USB port (in a single computer environment). In addition to being widely used solutions, these connection means also offer high bandwidth capabilities.

Further, an RS-232 port 90 is provided as a way to configure the VITA server for on-site communications and other preliminary settings necessary for first-time operation. The VITA server supports a number of hardware extensions such as a tape drive, hard disks, modems, etc. that can be added to the base configuration. The installation of many of these add-ons will be as much “plug and play” procedure as possible. That is, the VITA server will automatically sense the insertion of the device and will install the appropriate driver, followed by an optional configuration session, after which the device should be operational.

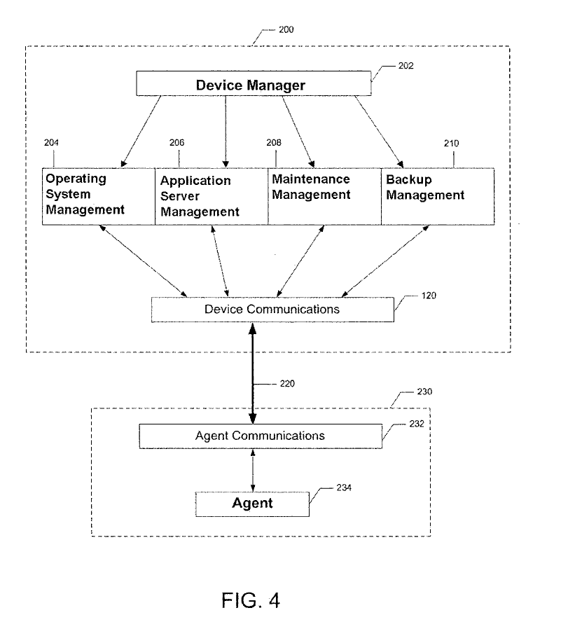

The primary maintenance functionality of the device of the present invention derives from its software modules that operate on one or more computers to be monitored and maintained. A high level depiction of the software architecture of the device of the present invention in communication with a client computer to be monitored is shown in FIG. 4. The VITA server 200 contains four primary management software modules, namely, (1) an operating system (OS) management module 204, (2) an application server management module 206, (3) a maintenance module 208; and (4) a data backup management module 210. The server 202 also includes a communication software 212 designed communication with the client computer 230 via a communications path 220, which as described above, can be the network bus or a direct communications link, such as a USB connection. Each client 230 includes a communications means 232 and a client program, called the “VITA Agent” that enables the client to communicate with and receive instructions and data from the server 200.

Reference is made now to FIG. 4, schematically presenting a level diagram describing the four basic software modules of the server of the present invention as follows:
1. Operating System Management Module—As its name states, the OS management module 204 contains all system management software—basic operations management—such as overseeing and offering options regarding the initial boot operation of the system, detecting and preventing system failures and resetting (turning on and off) a computer (whether or not in a failure mode). The basic configuration includes the following functionality described in greater detail.
   a. Enhanced Boot Capability—Conventionally, a computer is booted from a local hard disk. In more sophisticated systems, a computer may be booted from either a local hard disk or from a pre-designated server on the network in which the computer resides. In either case, these systems are typically confined to booting a specific OS. The server and system of the present invention, on the other hand, allows selecting one of many possible boot options from a menu, including booting different operating systems. This feature is called “a virtual boot” because it can use one of many boot images stored on the VITA server's hard drive. In addition, the ability to “boot” from a snapshot, and thus restore the computer to an exact state it was at a specific moment in time, offers robust and rapid solution to many computer failure situations.

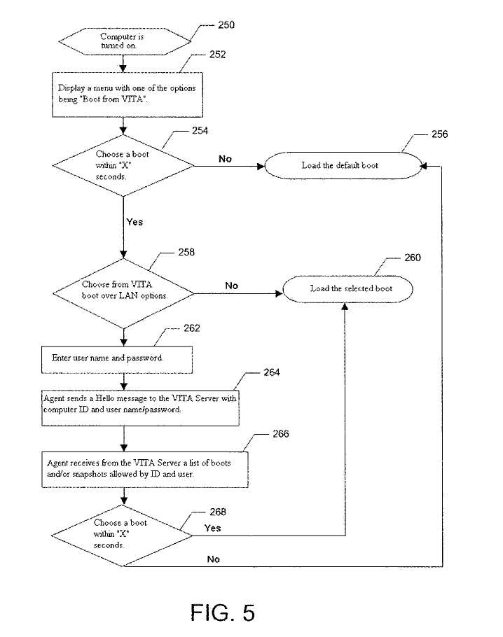

More particularly, the VITA server is installed at the master boot level. Thus, the server can provide the clients on the network with booting choices. As seen in the flow chart of FIG. 5, after the client computer (e.g. computer 230 in FIG. 4) is turned on in step 250, the user of the client is presented with a menu of boot options 252. The options include the computer being booted with an operating system provided by the VITA server on the network or from the boot partition on the user's hard drive. In the preferred embodiment, at 254, the user then has a few seconds within which to press a key in order to choose from which boot or “snapshot” to load. If the user does not choose an option within the predetermined time, a default boot, such as the local boot, is loaded 256.

If the user does select a boot, the system then queries which type of boot was selected, 258. If the “boot from VITA” option was not selected, then the selected boot is loaded at 260. If the “boot from VITA” option is selected the user is prompted with a request to enter his/her user name and password 262 onto the client. The agent 234 (in FIG. 4) then sends a handshake message to the VITA server 200 for authorization, 264. If approved, the agent, at 266, receives from the server a list of boot options and/or snapshot options to which the authorized user has rights. The user, at 268, must then choose within a predetermined time one of the boot options. If chosen, the selected boot is loaded at 260. For example, if the hardware is compatible and if the user has the rights, he can reboot his computer or another computer that he has access to, with a Linux, Windows 9X/NT/2000, UNIX or Macintosh operating system. The user can also restore a snapshot from a certain date and time and restore his machine to the exact state it was in when the snapshot was “taken.” For instance, if a snapshot was taken the previous week just before turning off the computer, the machine will be at that exact state after restoring from the snapshot. If the user does not select an option within the selection time allotted, the system reverts to loading the default boot at 256.
b. Snapshots—“Snapshots” are files, or images, which reflect the exact state of either the entire machine or the machine state for a specific application running on it. A machine snapshot includes information such as a copy of the microprocessor's internal registers, a copy of all RAM segments which contain program instructions and data, a copy of the stack(s), a copy of the heap(s), a copy of (parts) of the virtual memory swap file, a copy of the screen memory, and other internal machine data which reflect the exact machine state at the time the snapshot is taken. An application snapshot contains the same information but for the specific application only.

The VITA server is designed to take snapshots of either an entire machine or specific application(s), and can do so either upon a user or administrator request, or periodically according to a preset schedule whose interval can be set by the user. Snapshots are typically stored on VITA server's hard disk.

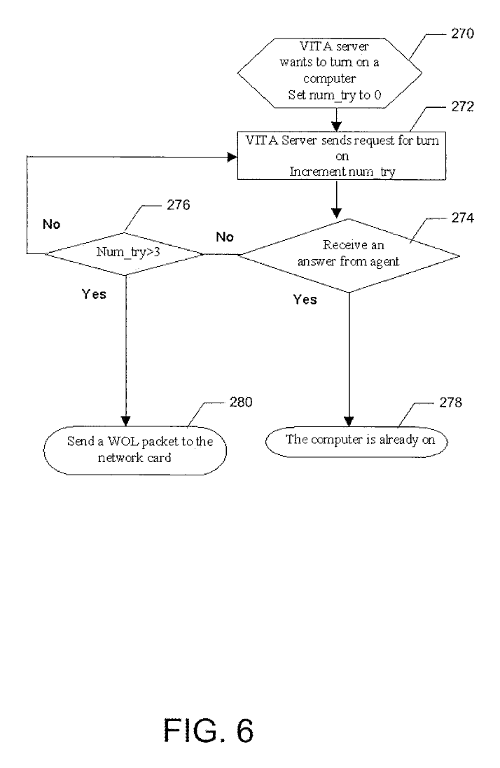

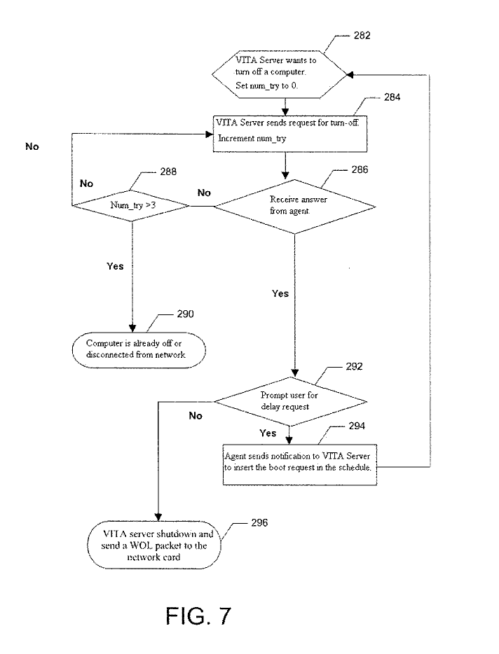

A snapshot of either the entire machine, or a specific application, can be restored by a user with the appropriate rights or by the administrator. This is especially useful if the system develops problems, which cannot be easily resolved using available OS tools (or cannot be resolved at all, as in the case of a major and compound system problem). In such a case, one of the snapshots stored in VITA can be used to restore the machine to a previously known stable state. There are other, more minute, reasons for restoring a machine from a snapshot, such as tracing back information or activities which have been since deleted or are otherwise inaccessible. It will be understood, however, that due caution must be exercised, of course, as all new information and data generated after the snapshot was taken, and which were not saved to files, will be lost when restoring from a snapshot. Unlike conventional systems on the market that only create an exact copy of the system's hard drive(s), for the purpose of later restoration in cases of a hard drive failure or the development of a serious problem in the OS, the VITA system captures all information about the state of the machine at a given point in time. The VITA server can also store numerous machine and application snapshots. It will be understood that the number of snapshots that are storable depends on the size of the VITA server's hard drive(s) and administrator settings.
c. Remote Reset—As seen in FIGS. 6 and 7, the VITA server's OS Maintenance Module 204 enables the server to reset (turn on or off) any targeted client on the network. FIG. 6 shows the process flow for when it is desired that the VITA server remotely turn on a selected client on the network. In such case, at step 270, a counter num_try is set to zero. Then, at 272, the server sends a request to a targeted client's agent 234 to power it up. At this point, the num_try counter is incremented by one. If, at 274, the server receives an answer from the client agent, that means either that the “turn on” request was successful or the computer is already powered up 278 and the process is at an end. However, if the server does not receive a reply, the system asks whether num_try is greater than three (that is, has the server tried more than three times). If not, the flow reverts to step 272 and the VITA server sends another request to turn the computer on and increments the counter by one. If the server again, at 274, does not receive an answer from the agent indicating the computer is on, the steps 276, 272, and 274 query loop proceeds again. If after three attempts the server does not receive a reply (i.e. num_try is greater than 3), the OSMM sends a “Wake on LAN packet to the network card, at step 280, and the process ends.

If it is desired that the VITA server remotely turn off a targeted computer on the network, then the flow shown in FIG. 7 is invoked. In particular, at 282, a num_try counter is set to zero. The VITA server then, at step 284, sends a request to the client to turn off the computer and increments the counter by one. The process then queries, at step 286, whether a response is received from the agent residing on the client. If it does not, then at step 288 the process queries whether num_try is greater than three. If not, the flow loops back to steps 284, with a counter increment, and query 286. If no response is received again, this loop continues until num_try is greater than three, at which point the system is “convinced” that the computer is either already off or disconnected from the network at step 290.

If the server does receive a response from the agent at 286, the flow moves to 292 whereat the user is prompted whether it wishes to request for a delay. If not, at 296, the server shuts the client computer off and sends a Wake on LAN packet to the network card. However, if the agent does request a delay, at 294, the agent sends a notification to the server to inset the specific boot request into the schedule. The flow then reverts back to step 282.
d. Crash Detection, Guarding and Repair—Another task of the OS Maintenance Module is to detect crashes or dysfunctions of the general system and specific applications.

On the application level, as is well known in the art, conventional crash detection and prevention software captures certain aspects of the application environment to guard from crashes. The present invention significantly enhances this capability as follows. Each time an application is launched by the operating system (excluding child processes) of a particular client 230, the VITA Agent 234 opens a popup window and offers the possibility of inserting the new application in a list of applications that are “crash guarded”. The next time the application is launched, the VITA server will start taking periodic snapshots of its working environment. Should a crash occur, the server would be able to restore the application to a previous stable state by restoring from the latest snapshot taken before the crash.

On the system level, as described above, the same procedures take place except that the snapshots are taken continuously while a machine is on, but usually at longer intervals, and restoration requires a higher privilege as it is a potentially more dangerous operation. The server's full machine snapshot captures, and thus can be used to restore, the machine to an exact state it was at the of the snapshot, including running applications, open windows, open documents, settings, preferences, etc.
2. Application Server Management Module—When installing an application program for the first time, the VITA server “learns” the installation process, including all changes and modifications to appropriate files (such as DLL's) in the operating system. Thus, the server can safely and easily uninstall the application when required. When uninstalling, the server actually saves all installation files and other information relating to user preferences, settings, etc., so that the next time a user asks for an installation, the server can restore the application on the client to the exact state it was at when last uninstalled. This “learn upon install” feature be used for the following two functions: i) A “smart,” automatic uninstall which doesn't require an uninstall utility and which also saves the exact state of the installed program, which is used for the following function; and ii) A “smart” re-install, which restores the application to its last installed state, keeping all user settings, preferences, etc.

Note that these functions are accomplished by the server and thus do not require an installation CD, as would be required using conventional methods.

Moreover, this feature enables the possibility that the administrator of the network may configure VITA with the number of licenses the company owns for each application program. Because VITA is in charge of all installation and un-installation requests, it can dynamically allow the installation of the licensed number of copies of a certain application on any of the machines on the network; when the entire number of allowed copies are installed, installation requests are placed in a queue, waiting for users to “release” a license by un-installing the application. To maximize the availability of a program to users when all the licenses are used up and new installation requests are sent to VITA, it employs two mechanisms to facilitate un-installation: (1) the server detects a user quitting a program and can perform an un-installation upon that event; and (2) the server detects idle programs (idle period settable by administrator) and presents the user of that copy of the software with a pop-up window asking whether he doesn't need the application anymore. If not needed, the application is uninstalled. In both scenarios, un-installation increases the number of allowable installations of the program.

Thus, assuming that at any given time, only a certain percentage of the users in an organization will need to concurrently use an application, a company can optimize the number of licenses it purchases for each program in anticipation of the number of concurrent users asking to install that program.

Certain conventional software packages contain functions that allow a smart (learning) installation, a smart un-installation, and re-installation of applications on a single PC. However, none of these systems dynamically allocate installation rights according to the number of licenses the company owns, in such a way that (1) complies with the majority of software license agreements and (2) allows installation on any of the machines on the network, up to the number of licenses owned. Although the current trend of “ASP” (Application Service Provider) might seem to be a competing technology, ASP actually uses the traditional methods of downloading programs and updating them online. It does not cater for dynamic allocation of licenses as VITA does, nor does it use centralized and automatic procedures for installation, un-installation and re-installation of software.
3. Maintenance Management Module—The following maintenance tasks/utilities can be performed individually upon request or the VITA Administrator can define batch jobs by selecting maintenance tasks and setting a schedule for each job. It is understood that many of these features are, and have been, offered for some time. The present invention places much, or all, of this functionality in a single server box that is remote from the client computers themselves. This enhances reliability and speed of the client computers to be maintained by shifting these functions away from them.
   a. Clean Temporary Files—This task deletes all temporary files and other files deemed unnecessary by the VITA server. This frees up storage space, improves access time and optimizes backup jobs.
   b. Scan for Viruses—This task is responsible for detecting and cleaning virus infection in boot records, files, e-mail messages, macros, etc. It uses automatic online updating to ensure up-to-the-minute virus detection and deletion.
   c. Defragment HD—This task is responsible for reorganizing the physical placement of the data on the hard drives for improving program launching and data access times. This module is file system and operating system dependent.
   d. Scan Disk—This task is responsible for checking the integrity of the file system and physical storage devices. This module is file system and operating system dependent.
   e. Checking for RAM use—This task is responsible for gathering statistics about the use of the RAM in order to determine whether there is a need to install more RAM for that user. This module is file system and operating system dependent
   f. Checking for Disk use—This task is responsible for gathering statistics about the use of the hard drive in order to determine whether there is a need to install a bigger hard drive for that user. This module is file system and operating system dependent. The VITA server can send an alert upon detecting a threshold previously defined by the administrator.
   g. Checking Application use—This task is responsible for gathering statistics about the use of application programs in order optimize the number of licenses purchased for various applications. This module is file system and operating system dependent. This is also an accessory tool for the Application Server Management module.
4. Backup Management Module—This module performs backup and restore tasks, which are essential for restoring information in such cases as a hard disk failure, unintentional deletion of files, etc. The VITA server can perform two major types of backup: (a) Full Backup—backs up all files on a selected drive or directory; and (b) Incremental Backup—only backs up those files that were created or modified since the last backup. This second option is useful for decreasing the size of the backup set (image of files) for all backups performed after the first.

Additional backup types are variations on these two types, with such changes as setting/not setting the archive (backed up) bit for files, etc.

The VITA server stores the backup set in any number of ways. In one embodiment, it may store the back-up on its own hard drive(s) or tape drive. In another embodiment, a hard drive of one of the machines on the network may be used.

The restore operation uses a backup set to automatically, or on demand, restore files after a hard drive failure, etc. Information about the type of backup is stored in the backup set, so usually there will not be a need to specify the type of restore. The restore function can access multiple incremental backup sets to restore the prior set of files that were backed up.

According to another embodiment of the present invention, the following describes the steps that would typically taken by the systems administrator to install and set up a VITA server on a LAN and make is functional in the environment.
a. The initial configuration of the VITA server is performed by a small utility program running on a computing device, such as a notebook PC, which is connected to the VITA server via the latter's RS-232 port. This initial configuration is required for the VITA server to become operational for the first time. At this point, the administrator defines the network parameters (IP, DNS, Gateway) for connecting VITA to the site's LAN, and the Modem parameters which VITA will need for connecting to a remote modem to provide remote access.
b. All hardware must be configured for both for the initial configuration of the VITA server and for later modifications of its hardware configuration. Although, as stated above, the VITA server uses the Plug and Play protocol for recognizing new hardware components, some devices may not comply with it and others, which do, still might need manual configuration (as is the case in the Windows OS).

A hard drive, modem network card, and tape drive are basic hardware components that would typically be used in a basic VITA server configuration. Notice that all of them are interchangeable with device as shown in the exemplary drawing of the VITA server hardware in FIG. 3. These devices span a wide range of cost, performance and functionality and will be determined by the specific application of the VITA server.
c. The authorized users of the VITA server, as well as the operations each user is permitted to perform, must be defined. For each user, three basic parameters are defined: (1) Username; (2) Password; and (3) Allowed Operations (rights). Note that the VITA server can extract the user list already stored on the site's server(s) and use the pertinent parts for determining the Allowed Operations or submit it to further editing for more specific definitions.
d. Configure/Add/Remove an automation—This is used to define one or more VITA tasks and setting a schedule for their execution. Automation includes: (1) A task or several tasks (a job) selected from the task list; (2) a schedule for execution, this can be a periodic (regular) schedule or a one-time; and (3) A client or a list of clients on which the tasks will be executed.

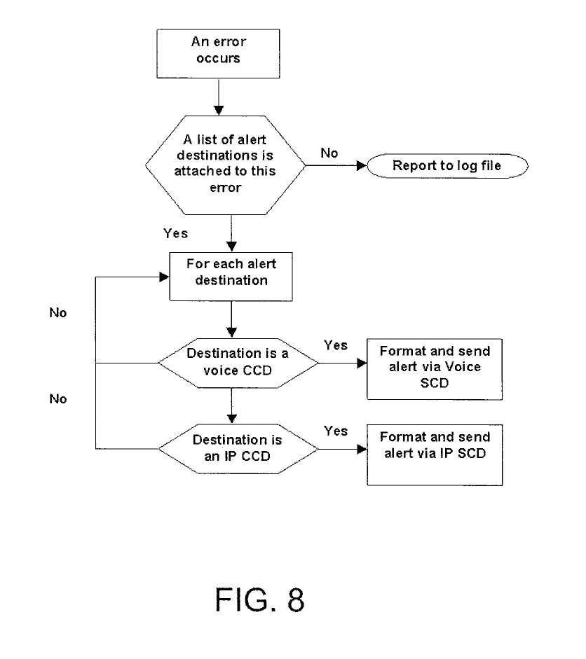

The server also permits the administrator to define a template of jobs, to which schedule and client parameters can be added later. This is useful for creating series of actions that need to execute at a specific order and are useful for multiple clients and schedules.
e. The administrator can define a list of jobs that will be executed for a given event. The algorithms in FIGS. 8, 9 and 10 show examples of such events. Each event is connected to a communication media that will alert one or more preprogrammed telephone numbers of one or more administrator. In response, the administrator(s) can activate a predefined job by pressing a key on the telephone set. The server recognizes the DTMF tones for the key. (DTMF is the standard protocol used universally by all touch-tone handsets).

While PAC functionality has been used extensively in other fields, such as remote notification of events in alarm systems, i.e. to call a control center with an alert about a possible intrusion, these systems are believed not be a bi-directional implementation of a PAC in computer systems. The system of the present invention is used to send an alert to a specific phone device upon encountering a problem situation and to enable a response to that alert by sending in DTMF codes to activate certain aspects of the system.
f. Install Client and Administrator—This will install a client program or an administrator program on one or more PCs in the site. Installation can be performed from a CD, VITA's built-in Web server, or VITA's website on the Internet. The content of the client program will be understood by those skilled in the art as one that enables the communication with and execution of the above-described features of the VITA server in its environment.

According to another embodiment of the present invention, there are two types of Communications Devices (CD's) defined by the present invention. Between the application level on each client side and server side, a lower level layer allows communications between them. They are the Server Communication Device (SCD) and the Client Communication Device (CCD). In addition, as stated above with reference with FIG. 3, internal and external communications have also been defined. They are related as follows and as seen in FIG. 4: the Internal SCD 120 connects the VITA server to each of the Internal CCD's 232 in each client. The Internal CCD can be the user agent on one of the computers on the network (e.g. a server, a workstation, . . . ) or the administration client for VITA running on one of the computers in the site. The external communications are used exclusively by the administrator. Turning back to FIG. 2, the External SCD can link the VITA server to two groups of External CCD's, namely an IP CCD 130 and a Voice CCD 132. The external IP CCD may be a Palm device, an email program, a Web browser, etc. The External Voice CCD may be an ordinary telephone used over a PSTN (public switched telephony network—the equipment and infrastructure used for normal telephone operation, which is provided by the telecom company), a mobile phone, a pager, etc.

Depending on the situation, the link may be established by either the SCD in case of an alert (such as an error or a problem situation on one of the computers in the site), or by the administrator via the CCD wishing to control or to manage the office network.

Alternative implementations of the External SCD are also possible. For example, when a connection must be established between an external SCD and an external IP CCD, a RAS service available on the site's server may be used. In fact, remote access to VITA server can be provided via the LAN's Ethernet line, which can spare the need for dedicated external communications and the line it needs. However, in the case where the office server itself has a problem or has crashed, access to the VITA server may be compromised. One convenient way to overcome this problem is to assign a true IP address to the VITA server and connect it directly to the router (optionally via a switcher). If this is not possible, (e.g. due to a firewall), an additional external SCD will be needed.

The device includes an artificial intelligence, or expert system module. The module handles problem resolution based on a given status including various system, hardware and application data. In the first stage this module is applied to the two modules ASM and OSM. The data required includes DLL, OCX and COM configuration for applications, and driver and hardware configuration with regard to the operating system and its components.

Having thus described exemplary embodiments of the invention, it will be apparent that further alterations, modifications, and improvements will also occur to those skilled in the art. Further, it will be apparent that the present device and technique is not limited to any particular network environment, but can include any type of wired or wireless network, network topology and size that connects any of a variety of types computing devices (PC's, workstations, notebooks, appliances), that can benefit from the features and efficiencies described herein. Accordingly, the invention is defined only by the following claims.

1. A computer supervising device, comprising:
(a) a processor;
(b) internal memory in communication with the processor;
(c) a storage device in communication with the processor;
(d) an internal bus that provides a communication path between the processor, memory and storage device;
(e) an operating system in communication with the processor;
(f) a data maintenance management module that operates from the memory;
(g) an operating system management module that that operates from the memory;
(h) communications means for communicating with computers to be supervised; and
(i) an interface that integrates all supervising functions in a single interface.

2. The device according to claim 1, additionally comprising remote communications means for enabling communication with remote control devices.

3. The device according to claim 2, wherein the remote communications means includes a bi-directional phone access control (PAC) component.

4. The device according to claim 2, wherein the remote communications means includes the TCP/IP protocol.

5. The device as defined in claim 1, comprising:
(a) a processor;
(b) internal memory in communication with the device's processor;
(c) a storage device in communication with the device's processor;
(d) an internal bus that provides a communication path between the device's processor, memory and storage device;
(e) an operating system in communication with the device's processor;
(f) a data maintenance management module that operates from the internal memory that is adapted to
(i) dynamically back up data stored on the storage device of each of the selected computers to a backup storage device associated with the independent device,
(ii) maintain temporary files stored on the storage device,
(iii) scan the storage device for viruses,
(iv) scan the storage device to maintain file system integrity and storage optimization, and
(v) manage storage device usage;
(g) an operating system management module that that operates from the memory and that is adapted to
(i) selectively boot and reboot a selected operating system onto a selected computer;
(ii) detect operating system failures in the selected computers and
(iii) in the event of a failure of an operating system of one or more of the selected computers, restoring the operating system to a prior stable operating state;
(h) network communications means for communicating with the selected computers to be supervised; and
(i) remote communications means for enabling remote control of the device, wherein the device is independent from the computers on the network.

6. A self-monitoring computer maintenance system for maintaining a network of computers, including:
a. the device as claimed in claim 3; and
b. a computer maintenance administration module connectable to the device and adapted to control the device.

7. A method of maintaining a computer system having a processor, an operating system, main memory and a storage device, comprising:
a. in an independent, processor-based device in communication with the computer system, selecting one or more predefined maintenance tasks to be performed; and
b. executing from the device the one or more tasks on the computer system.

8. The method according to claim 7, additionally comprising prior to executing, scheduling the one or more predefined maintenance tasks for execution.

9. The method according to claim 7, wherein the predefined maintenance tasks comprising:
a. managing the operating system of the computer system; and
b. managing data stored on the storage device of the computer system.

10. The method according to claim 9, wherein the managing of the data stored on the storage device includes dynamically backing up the data to a backup storage device associated with the independent device.

11. The method according to claim 7, wherein the independent device includes a real-time operating system.

12. The method according to claim 8, wherein the one or more predefined maintenance tasks to be executed are scheduled remotely from the device.

13. The method of claim 1, wherein the one or more predefined maintenance tasks to be performed are selected remotely from the device.

14. A method of maintaining a network of computers, comprising:
a. selecting, in an independent, processor-based device in communication with the network of computers, one or more computers on the network to be maintained;
b. selecting, from the independent device, one or more predefined maintenance tasks to be perforined on each of the selected computers; and
c. executing the one or more selected predefined maintenance tasks on each of the selected computers.

15. The method according to claim 14, additionally comprising prior to executing, scheduling the one or more selected maintenance tasks for execution.

16. The method according to claim 15, wherein the executing of the one or more selected maintenance tasks recurs on each of the selected computers according to the scheduling.

17. The method according to claim 14, wherein each of the selected one or more computers on the network includes a processor, an operating system, main memory and is associated with a storage device, and wherein the one or more predefined maintenance tasks to be performed comprises:
a. managing the operating system of each of the one or more selected computers on the network; and
b. managing data stored on the storage device associated with each of the one or more selected computers on the network.

18. The method according to claim 17, wherein the managing of the operating systems of the selected computers includes at least one of:
a. booting and rebooting an operating system onto a selected computer;
b. detecting failures in the operating systems of the selected computers; and
c. in the event of a failure of an operating system of one or more of the selected computers, restoring the operating system to a prior stable operating state.

19. The method of claim 17, wherein the managing of the data stored on the storage device associated with each of the selected computers includes at least one of:
a. maintaining temporary files stored on the storage device;
b. scanning the storage device for viruses;
c. scanning the storage device to maintain file system integrity and storage optimization; and
d. managing disk usage.

20. The method according to claim 17, further including managing the main memory of each of the selected computers.

21. The method according to claim 20, wherein the managing of the main memory includes:
a. monitoring each of the selected computer's main memory usage; and
b. optimizing each of the selected computer's main memory usage.

22. The method of claim 17, wherein the network of computers comprises a heterogeneous operating system environment, and the method further includes automatically detecting the operating system platform of each of the selected computers to be managed.
